(19) United States
(12) Patent Application Publication
(10) Pub. No.: US 2005/0158693 A1
(43) Pub. Date: Jul. 21, 2005

(54) Dental alloys

(76) Inventors: Arun Prasad, Cheshire, CT (US); Nikhil K. Sarkar, New Orleans, LA (US)

Correspondence Address: PENTRON CORPORATION, 53 NORTH PLAINS INDUSTRIAL ROAD, WALLINGFORD, CT, 06492, US

(21) Appl. No.: 10/420,365

(22) Filed: Apr. 22, 2003

Related U.S. Application Data
(60) Provisional application No. 60/374,396, filed on Apr. 22, 2002.

(51) Int. Cl. A61C 13/08

(52) U.S. Cl. 433/207

(57) ABSTRACT

A dental alloy that comprises little or no amounts of noble metals. The alloys herein are designed to be a substitute for gold alloys in the fabrication of prosthetic dental appliances employing porcelain to metal bonds. The alloys are based on a combination of iron and chromium with a lesser inclusion of other elements to provide a high yield strength and to provide a durable impact resistant bond with dental porcelain.

### CROSS-REFERENCE TO RELATED APPLICATIONS

This application claims priority to U.S. Provisional Application No. 60/374,396, filed Apr. 22, 2002, which is hereby incorporated by reference.

### FIELD OF THE INVENTION

This invention provides nickel and beryllium free, iron-chromium based alloys for uses in restorative dentistry. The applications may range from fixed prostheses to removable partial dentures. Prostheses may be veneered with conventional dental porcelains or composite resins to enhance esthetic qualities.

### BACKGROUND OF THE INVENTION

The explosion in the price of gold in the early to mid seventies resulted in a search for alternatives to gold-based dental alloys. The search led to the development of palladium-silver and non-precious alloy systems. The introduction of high palladium alloys in the early eighties further strengthened the armamentarium of dental alloys and they quickly became favorites as they offered much reduced potential for porcelain discoloration and better mechanical properties. In recent past, the price of palladium and gold has escalated as high as $1000 and $375 per ounce, respectively. Although cobalt-chrome based and titanium systems are available and address the earlier mentioned concerns, they have not become popular for porcelain-fused-to-metal (PFM) restorations due to their poor and complex handling characteristics. In fact, today there is resurgence towards the use of relatively expensive gold-based alloys. Presently, nickel and cobalt based alloys are inexpensive in comparison to precious counterparts. However, there is no indigenous source of these materials in the United States and some day we may be at the mercy of other foreign suppliers. Scenarios may develop for these base metals similar to those we are facing with noble metals today. It has been noted that there is a potentially dwindling supply of numerous metals used in dentistry. Thus, there is a need for an alloy system that relies primarily on indigenously produced material, that is economical or less expensive than nickel or cobalt systems, is resistant to corrosion and tarnish, is bio-compatible, and offers good handling, thermal and mechanical properties.

### SUMMARY OF THE INVENTION

These and other objects and advantages are accomplished by the alloys of the present invention that comprise little or no amounts of noble metals. The alloys herein are designed to be a substitute for gold alloys in the fabrication of prosthetic dental appliances employing porcelain to metal bonds. The alloys are based on a combination of iron and chromium with a lesser inclusion of other elements necessary to impart the desired properties to be described herein, including high yield strength, the capacity of forming a durable impact resistant bond with dental porcelain, ductility so that the dentist may make minor adjustments without fear of damaging the prosthetic appliance, good polishabillty, and a hardness comparable to natural teeth so that the patient's natural teeth are not damaged by contacting the alloy.

### DETAILED DESCRIPTION OF THE INVENTION

The alloy compositions of the present invention have the following range of constituents by weight percentages as set forth in Table 1.

TABLE 1

| | | PREFERRED | MOST |
|---|---|---|---|
| ELEMENTS | RANGE | RANGE | PREFERRED |
| Fe | Balance | Balance | Balance |
| Cr | about 5 to | about 5 to about | about 15 to about |
| | about 30 | 25 | 25 |
| One or more of | about 0.1 to | about 0.1 to | about 0.1 to |
| Mn, Ga, In, Sn, | about 25 | about 15 | 10 |
| Ge, Zn | | | |
| One or more of | 0 to about 2 | 0 to about 1 | 0 to about 1 |
| Li, Se, Y, B, C, | | | |
| N, Re | | | |
| One or more of | 0 to about 30 | about 2 to about | about 2 to about |
| Mo, W, Ta, V, | | 20 | 10 |
| Nb, Ni, Co, Ti | | | |
| One or more of | 0 to about 5 | 0 to about 4 | 0 to about 3 |
| Cu, Ag, Rare | | | |
| Earths | | | |
| One or more of | about 0.1 to | about 0.1 to | about 0.1 to about |
| A1,Si | about 10 | about 6 | 6 |
| One or more of | 0 to about 25 | about 2 to about | about 2 to about 5 |
| Au, Pt, Pd, Ru, Ir, | | 25 | |
| Rh, Os | | | |

The required constituents of the alloys are iron and chromium along with one or more of manganese, gallium, indium, tin, germanium, and zinc and one or more of aluminum and silicon.

Chromium primarily enhances resistance to corrosion. Further enhancement can be derived through additions of gold, platinum-group metals, silver, and austenite stabilizers such as molybdenum, nickel, vanadium, and the like. Lowering of the melting temperature is primarily controlled via the addition of manganese, gallium, germanium, aluminum, and silicon. These constituents also affect mechanical and thermal properties. Manganese, gallium, indium, tin and aluminum raise the coefficient of thermal expansion while molybdenum and tungsten help lower it. Oxidation resistance of the alloy is controlled via additions of elements such as aluminum, chromium, yttrium or rare earths. Nitrogen, carbon and boron help control the amounts of nitrides, carbides and borides in the microstructure and thus the strength and ductility properties of the alloys. The individual or combined amounts of gallium and germanium, when present, should be kept below about 15%. Similarly, the amounts of indium, tin and zinc (each or combined) should be kept below about 7%.

The alloys may be prepared in a conventional manner such as by placing the components in a fused alumina crucible and fusing the ingredients with appropriate mixing. While in the molten state, the alloy may be poured into molds for ingot formation.

The following Table 2 illustrates examples of the present invention.

TABLE 2

| | Alloy | Alloy | Alloy | Alloy | Alloy | Alloy |
|---|---|---|---|---|---|---|
| Elements | #1 | #2 | #3 | #4 | #5 | #6 |
| Fe | Balance | Balance | Balance | Balance | Balance | Balance |
| Cr | 15 | 25 | 20 | 25 | 20 | 10 |
| Al | 3 | 6 | 0 | 0.5 | 0 | 0.25 |
| Si | 0 | 0 | 1 | 0 | 2 | 0 |
| Ga | 2 | 0 | 0 | 10 | 0 | 2 |
| Mn | 0 | 1 | 10 | 0 | 15 | 0 |
| In | 0 | 0 | 0 | 0 | 0 | 0 |
| Sn | 0 | 0 | 0 | 0 | 0 | 0 |
| Ge | 0 | 0 | 0 | 0 | 0 | 0 |
| Zn | 0 | 0 | 0 | 0 | 0 | 0 |
| Li | 0 | 0.15 | 0 | 0 | 0 | 0 |
| Y | 0.15 | 0 | 0 | 0 | 0 | 0 |
| Sc | 0 | 0 | 0 | 0 | 0 | 0 |
| B | 0 | 0 | 0 | 0 | 0 | 0 |
| N | 0 | 0 | 0 | 0 | 0 | 0 |
| Re | 0 | 0 | 0 | 0 | 0 | 0 |
| Cu | 0 | 0 | 0 | 1 | 0 | 0 |
| Ag | 0 | 0 | 0 | 0 | 0 | 0 |
| Rare | | | | | | |
| Earths | 0 | 0 | 0 | 0 | 0 | 0 |
| Mo | 0 | 0 | 0 | 0 | 3 | 0 |
| W | 0 | 0 | 0 | 0 | 0 | 0 |
| Ta | 0 | 0 | 0 | 0 | 0 | 0 |
| V | 0 | 0 | 0 | 0 | 0 | 0 |
| Nb | 0 | 0 | 0 | 0 | 0 | 0 |
| Ni | 0 | 0 | 0 | 0 | 0 | 0 |
| Co | 0 | 10 | 0 | 5 | 0 | 15 |
| Ti | 0 | 0 | 0 | 0 | 0 | 0.25 |
| Au | 0 | 0 | 0 | 0 | 0 | 0 |
| Pt | 0 | 0 | 0 | 0 | 0 | 0 |
| Ru | 0 | 0 | 0 | 0 | 0 | 0 |
| Rh | 0 | 0 | 0 | 0 | 0 | 0 |
| Os | 0 | 0 | 0 | 0 | 0 | 0 |
| Ir | 0 | 0 | 0 | 0 | 0 | 0 |
| Pd | 0 | 0 | 0 | 0 | 0 | 25 |

The dental alloys of the present invention intended for use as structural metals may be employed in the replacement of the denser and more expensive gold which has been the conventional structure metal used for dental purposes. The alloys are ideally suited for use where bonding of the alloy to a porcelain is required, as in the preparation of artificial teeth, crowns, bridges and the like.

For porcelain-fused-to-metal PFM restorations, it is desired that the thermal coefficient of expansion of the alloys be greater than that of the porcelains being used for veneering. The thermal coefficient of expansion of these alloys can be varied between about 8 to about 19×10⁻⁶ K⁻¹ in the temperature range of from about 25 to about 500° C. The melting range can be varied for the intended applications and is in the range of from about 900 to about 1500° C. Alloys having a lower melting range are desirable for cast crowns, bridges and removable partial dentures. Alloys for PFM restorations should have a melting range of at least about 100° C. higher than the firing temperature of the porcelains. Currently porcelains having fusion temperatures and thermal coefficients of expansion compatible with the alloys described herein are available. The yield strength of the alloys as per ISO Specification 9693 is above about 250 MPa and the elongation in accordance with Type III alloys is 2%.

Methods of preparing dental constructions, appliances, prostheses, crowns, bridges and the like involve preparing a metal core by casting the dental alloy, applying a porcelain to the metal core, whereby the porcelain has a coefficient of thermal expansion in the range of from about 7×10⁻⁶/°K to about 18×10⁻⁶/°K, and firing the porcelain onto the metal core. Removable dental prostheses may be fabricated by casting a dental alloy to make a frame, and optionally placing a resinous or acrylic material around the alloy. A fully cast crown or bridge may be fabricated by fully casting the alloys herein described.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

1. A dental alloy comprising by weight percent:
about 5 to about 30% Cr;
about 0.1 to about 25% of one or more of Mn, Ga, In, Sn, Ge, and Zn;
about 0.1 to about 10% of one or more of Al and Si; and
the balance being Fe.

2. The dental alloy of claim 1 further comprising:
up to about 2% of one or more of Li, Se, Y, B, C, N, and Re;
up to about 30% of one or more of Mo, W, Ta, V, Nb, Ni, Co, and Ti;
up to about 5% of one or more of Cu, Ag, and rare earth metals; and
up to about 25% of one or more of Au, Pt, Pd, Ru, Ir, Rh and Os.

3. The dental alloy of claim 1 having a coefficient of thermal expansion in the range of about 8 to about 19×10⁻⁶ K⁻¹ in the temperature range of from about 25 to about 500° C.

4. The dental alloy of claim 1 wherein the yield strength is greater than about 250 MPa.

5. The dental ally of claim 1 wherein the melting range is from about 900 to about 1500° C.

6. A dental alloy comprising:
about 5 to about 25% Cr;
about 0.1 to about 15% of one or more of Mn, Ga, In, Sn, Ge, and Zn;
about 2 to about 20% of one or more of Mo, W, Ta, V, Nb, Ni, Co, and Ti;
about 0.1 to about 6% of one or more of Al and Si;
about 2 to about 25% of one or more of Au, Pt, Pd, Ru, Ir, Rh and Os; and
the balance being Fe.

7. The dental alloy of claim 6 further comprising: up to about 1% of one or more of Li, Se, Y, B, C, N, and Re; and up to about 4% of one or more of Cu, Ag, and rare earth metals.

8. A dental alloy comprising: about 15 to about 25% Cr; about 0.1 to about 10% of one or more of Mn, Ga, In, Sn, Ge, and Zn; about 2 to about 10% of one or more of Mo, W, Ta, V, Nb, Ni, Co, and Ti; about 0.1 to about 6% of one or more of Al and Si; about 2 to about 5% of one or more of Au, Pt, Pd, Ru, Ir, Rh and Os; and the balance being Fe.

9. The dental alloy of claim 8 further comprising:
up to about 1% of one or more of Li, Se, Y, B, C, N, and Re; and
up to about 3% of one or more of Cu, Ag, and rare earth metals.

10. A method of preparing a dental construction comprising:
(a) preparing a metal core by casting the dental alloy of claim 1;
(b) applying to the surfaces of the metal core a porcelain having a coefficient of thermal expansion in the range of from about 7×10⁻⁶/°K to about 18×10⁻⁶/°K; and
(c) firing the porcelain onto the metal core.

11. A method of preparing a dental construction comprising:
(a) preparing a metal core by casting the dental alloy of claim 6;
(b) applying to the surfaces of the metal core a porcelain having a coefficient of thermal expansion in the range of from about 7×10⁻⁶/°K to about 18×10⁻⁶/°K; and
(c) firing the porcelain onto the metal core.

12. A method of preparing a dental construction comprising:
(a) preparing a metal core by casting the dental alloy of claim 8;
(b) applying to the surfaces of the metal core a porcelain having a coefficient of thermal expansion in the range of from about 7×10⁻⁶/°K to about 18×10⁻⁶/°K; and
(c) firing the porcelain onto the metal core.

13. A method of preparing a removable dental prosthesis comprising:
casting the dental alloy of claim 1 to make a frame.

14. The method of claim 13 further comprising:
placing a resin material around the alloy.

15. The method of claim 14 wherein the resin material comprises acrylic.

16. A method of preparing a fully cast crown or bridge comprising:
fully casting the dental alloy of claim 1.

17. A method of preparing a removable dental prosthesis comprising:
casting the dental alloy of claim 6 to make a frame.

18. The method of claim 17 further comprising:
placing a resin material around the alloy.

19. The method of claim 18 wherein the resin material comprises acrylic.

20. A method of preparing a fully cast crown or bridge comprising:
fully casting the dental alloy of claim 6.

21. A method of preparing a removable dental prosthesis comprising:
casting the dental alloy of claim 8 to make a frame.

22. The method of claim 21 further comprising:
placing a resin material around the alloy.

23. The method of claim 22 wherein the resin material comprises acrylic.

24. A method of preparing a fully cast crown or bridge comprising:
fully casting the dental alloy of claim 8.
